(19) United States
(12) Patent Application Publication
(10) Pub. No.: US 2023/0212871 A1
(43) Pub. Date: Jul. 6, 2023

(54) Night Sky Viewing Tent Structures

(71) Applicants: Lun Xu, Pasadena, CA (US); Xuduo Wen, Pasadena, CA (US)

(72) Inventors: Lun Xu, Pasadena, CA (US); Xuduo Wen, Pasadena, CA (US)

(21) Appl. No.: 17/565,750

(22) Filed: Dec. 30, 2021

(51) Int. Cl. E04H 15/02; E04H 15/54; G02B 25/00; G02B 5/23

(52) U.S. Cl. CPC E04H 15/02; E04H 15/54; G02B 25/002; G02B 5/23; E04H 15/40

(57) ABSTRACT

A night sky viewing tent structure having specific features for enhanced night sky viewing is disclosed. In one embodiment, the night sky viewing tent structure comprises roof cut-outs to allow telescope lenses to extend through the roof for star viewing while still protecting users. In other embodiments, the tent structure roof cover is at least partially transparent with one or more sections providing magnification for improved night sky viewing. In another embodiment, the tent structure covering is at least partially photochromic, such that it is clear in low light conditions, and substantially tinted in full light or day light conditions. In other embodiments, the tent structure cover is manufactured with one or more coatings to absorb ultraviolet rays of less than 400 nanometers. In various embodiments, the night sky viewing tent structure is formed using at least one flexible rib element and a cover element.

### BACKGROUND

Tents and tent-type structures are widely used in a very broad spectrum of applications. Indeed, tents are used for a multitude of activities including applications such as camping, beach time, sun protection, wind and rain protection, play tents, pet enclosures, and even shower or changing enclosures. Depending upon the design and covering, such structures and coverings provide protection from wind, rain, and, especially in the beach environment, protection from the sun and ultraviolet light. One important feature for most all tent structures used in an outdoor temporary setting is that the structure must be readily portable so that it can be transported to where it will be used, and readily storable when not in use.

While tent structures have been used for ages as a portable structure for protection and privacy, such current and prior art structures generally have limited utility for use at night to view the night sky. This is because most all current tent structures have a solid roof or ceiling section. Such designs preclude the ability of users within the tent structure to view the night sky, including viewing stars, planets, or other night sky features.

While some designs provide for some flexibility with respect to the structure and size of the tent, such size and configuration flexibility is very limited, and generally does not provide any means for flexibility in the configuration or structure.

Accordingly, it would be useful to have a portable tent structure that can be used at night to provide some protection from the outside environment, but that would also allow users to have a clear view of the night sky. Such an innovative tent structure could include one or more features such as cut-outs to allow for telescope usage; roof sections having magnification capabilities; and/or photovoltaic panels with batteries and lighting elements.

Moreover, the night viewing tent structure should be lightweight, and in the disassembled or folded configuration, be easy to store and transport. Such a night viewing tent structure does not appear to have been designed, developed, or commercialized that satisfactorily meets each of these criteria. While certain of these problems may be addressed by one or more examples of the prior art, a complete solution to all of these problems does not appear to have been specifically designed or used in the relevant prior art.

### SUMMARY OF THE INVENTION

The present invention overcomes the disadvantages of the prior art and fulfills the needs described above by providing a modular tent structure that includes a plurality of side panels that may be detached from each other, or added to the structure to provide for a wide variation of tent configurations and shapes for varied uses.

One preferred embodiment of the invention is an outdoor tent for night sky viewing, comprising a plurality of flexible ribs; a flexible cover attachable to said plurality of flexible ribs to form a tent structure, wherein said flexible cover is substantially transparent for at least approximately 33% of the top of said tent structure; has at least one openable side door panel; and has at least one opening in the top of said tent structure for a telescope lens to extend through.

A second preferred embodiment of the invention is outdoor tent for night sky viewing, comprising a plurality of flexible ribs; a flexible cover attachable to said plurality of flexible ribs to form a tent structure, wherein said flexible cover is substantially transparent for at least approximately 50% of the top of said tent structure; has at least one openable side door panel; and has at least one opening in the top of said tent structure for a telescope lens to extend through; and further where the tent structure transparent top section has at least one magnifying portion.

A third preferred embodiment of the invention is outdoor tent for night sky viewing, comprising a plurality of flexible ribs; a flexible cover attachable to said plurality of flexible ribs to form a tent structure, wherein said flexible cover is substantially transparent for at least approximately 50% of the top of said tent structure; has at least one openable side door panel; and has at least one opening in the top of said tent structure for a telescope lens to extend through; further where the flexible cover is manufactured with at least one coating that absorbs light radiation below approximately 500 nm.

A fourth preferred embodiment of the invention is outdoor tent for night sky viewing, comprising a plurality of flexible ribs; a flexible cover attachable to said plurality of flexible ribs to form a tent structure, wherein said flexible cover is substantially transparent for at least approximately 50% of the top of said tent structure; has at least one openable side door panel; and has at least one opening in the top of said tent structure for a telescope lens to extend through; further where the flexible cover is manufactured with photochromic features such that the flexible cover is substantially clear in low light or night conditions, and substantially tinted in full light or daylight conditions.

A fifth preferred embodiment of the invention is an outdoor tent for night sky viewing, comprising a single flexible rib in an approximate oval shape; a flexible cover attachable to said single flexible rib to form a tent structure when opposite sides of said single flexible rib are folded towards each other, and wherein said flexible cover is substantially transparent for at least approximately 50% of the top of said tent structure; has at least one openable side door panel; has at least one opening in the top of said tent structure for a telescope lens to extend through.

Another preferred embodiment of the invention is outdoor tent for night sky viewing, comprising a plurality of flexible ribs; a flexible cover attachable to said plurality of flexible ribs to form a tent structure, wherein said flexible cover is substantially transparent for at least approximately 50% of the top of said tent structure; has at least one openable side door panel; and has at least one opening in the top of said tent structure for a telescope lens to extend through; further comprising at least one photovoltaic panel used to generate electrical power that may be stored in at least one energy storage device, and used to power lights or used to recharge electrical devices.

### BRIEF DESCRIPTION OF THE DRAWINGS

To easily identify the discussion of any particular element or act, consistent element numbers refer to such elements in different figures.

FIG. 1 is a perspective or isometric front view of an embodiment of the inventive night sky viewing tent having two sections for telescope usage.

FIG. 2 is a perspective or isometric front view of an embodiment of the inventive night sky viewing tent having two sections for telescope usage and showing exemplary positioning for two telescopes.

FIG. 3 is a perspective or isometric front view of an embodiment of the inventive night sky viewing tent, along with a detailed view of the layer construction of the viewing tent top section.

FIG. 4 is a side view of an embodiment of the inventive night sky viewing tent showing exemplary door, window, and vent elements.

FIG. 5 is a further side view of an embodiment of the inventive night sky viewing tent showing exemplary door, window, and vent elements.

FIG. 6 is a top view of an embodiment of the inventive night sky viewing tent.

FIG. 7 is a side view of an embodiment of the inventive night sky viewing tent with photovoltaic panels, lights, and energy storage incorporated into an upper section of the tent.

### DETAILED DESCRIPTION OF CERTAIN EMBODIMENTS

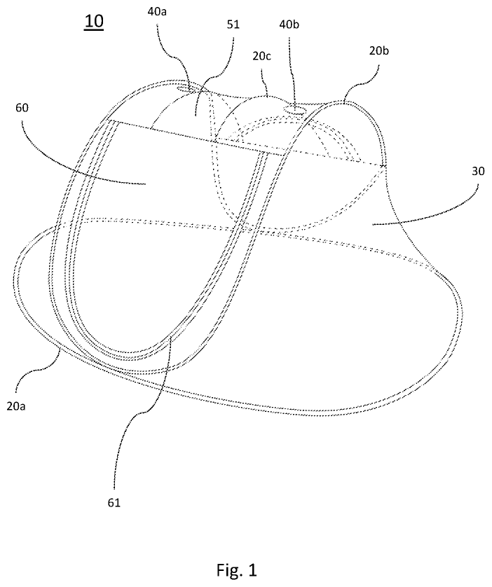

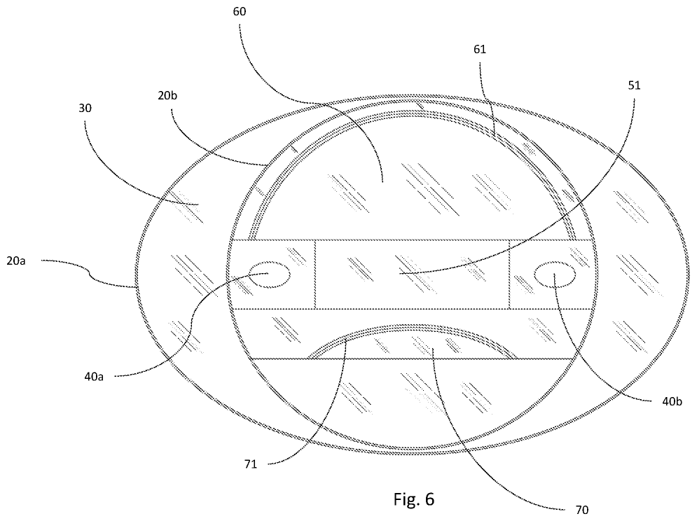

An innovative, multiple feature night sky viewing tent structure is disclosed and described in various relevant and useful embodiments. The night sky viewing tent structure 10 is shown in different embodiments in FIGS. 1 through 7.

At its core, the night sky viewing tent structure 10 is comprised of at least one flexible support rib 20 and a cover 30 that is at least partially transparent. As shown, in one embodiment in FIG. 1, the tent structure 10 may be assembled having two or more support ribs 20a, 20b, 20c that form the skeletal support structure of the tent 10 to which the cover 30 is attached. In the FIG. 1 embodiment, the support ribs form the skeletal structure for the bottom or footprint of the tent structure 10, using support rib 20a, and also forms the skeletal support structure for the upper portion of the tent structure 10, using support rib 20b. In other embodiments, the support ribs may be combined into a single flexible support rib, or alternatively be configured such that the support ribs 20a, 20b, 20c are formed from a plurality of sub-support rib sections that are interconnected to form support ribs 20a, 20b, 20c as shown in FIGS. 1 through 7.

As shown in different configurations, in FIGS. 1 through 7, support ribs 20c provide support for the tent structure 10 roof shape. A typical configuration has two support ribs 20c that form a convex shape to the tent structure 10 roof line.

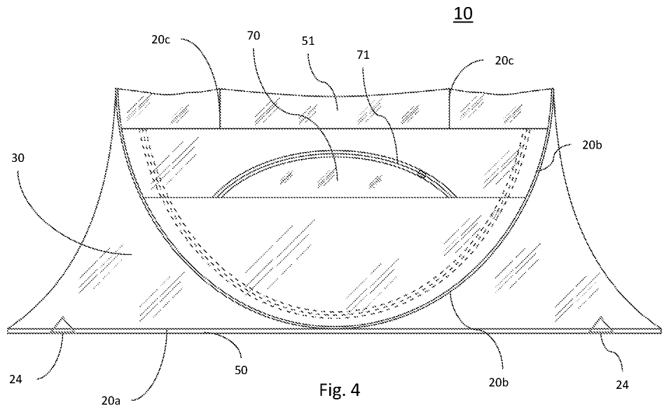

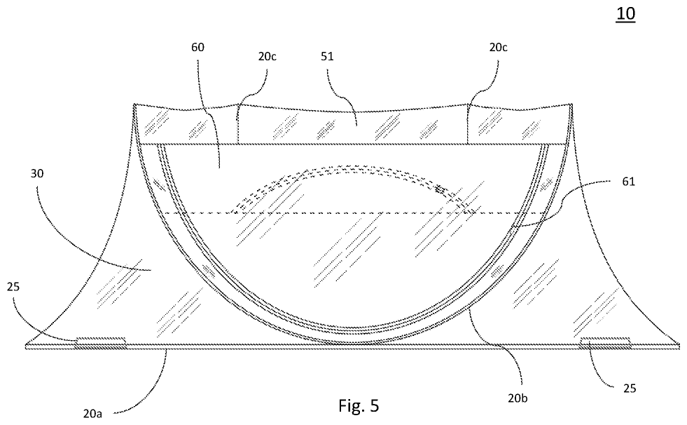

The cover 30 may be attached to the support ribs 20a, 20b, 20c through the use of various fasteners 24, as illustrated in FIG. 4. Such fasteners could be, in different embodiments, textile hook and loop sections and/or tie ends. In another embodiment, as shown in FIG. 5, the cover 30 may be formed with sleeve sections 25 through which the support ribs are slid to form the tent structure 10.

To allow for user ease of use and comfort, the tent structure 10 may also incorporate one or more door sections 60 and window sections 70. The door section 60 may be opened or closed through fasteners 61, which in one embodiment as shown in FIG. 1, may be a zipper 61. Similarly, the window section 70 may be opened or closed through use of fasteners 71, which in one embodiment, as shown in FIG. 1, may again be a zipper 71. Alternative forms of fasteners that may be equally applicable and useful are snaps, buttons, or attracting magnet elements that are embedded into the cover 30 and door section 60 or window section 70 edges, or hook and loop textile material or strips.

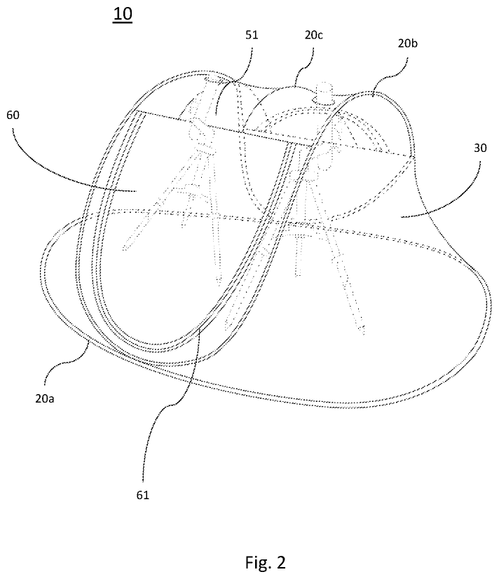

A core feature that enhances the utility of the tent structure 10 is the incorporation of an upper or roof section 50 of the tent structure 10 that has several enhancements for viewing the night sky. One such enhancement may be the incorporation of one or more cut outs 40a, 40b, as shown in FIGS. 1 through 7. These cut outs 40a, 40b allow the user to extend a telescope lens through the cut out 40a, 40b, as shown in FIG. 2. More, specifically as shown in FIG. 2, the tent structure 10 upper section 50 has two cut outs 40a, 40b, allowing for the use of two telescopes within the tent, but with the distal end of the telescope extending through the tent structure upper section 50, thereby providing an unobstructed view of the night sky.

With the tent structure 10 having an upper or roof section 50 with cut outs 40a, 40b, a user may set up his or her telescope within the tent structure 10 to provide protection of the user, and protection for the user's telescope, from the environment, and yet still have an unobstructed view of the night sky. The noted environment protection could be protection from the cold, wind, dust, or insects or other pests, or other elements.

A further feature of the tent structure 10 may be the use of one or more sections 51 in the tent structure 10 upper section 50, that is transparent to allow unaided viewing of the night sky. In a preferred embodiment, the transparent section of the upper section 50 should be at least 33% of the total area of the tent structure roof section 50.

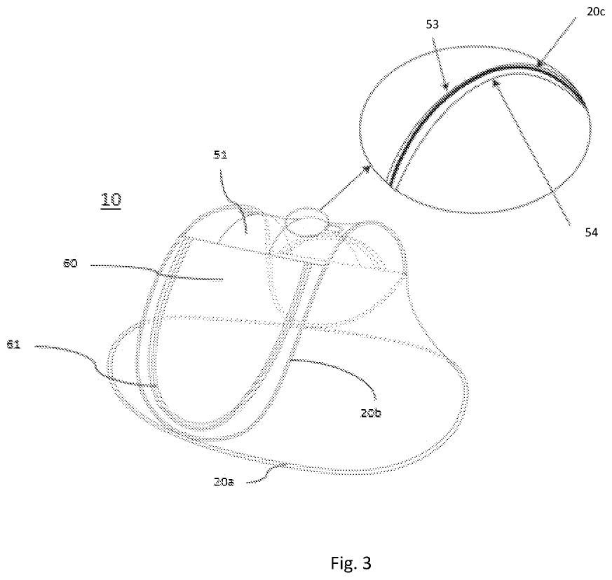

Another feature of the tent structure 10 upper section 50 may include an enhanced magnification such that the user, when viewing the night sky through the magnified upper section 51, sees an enhanced or magnified view of the night sky. This allows users to view the stars, the moon, or other celestial objects with a magnified view. The magnified upper section 51 may be constructed as a single layer having lens magnification characteristics, or alternatively, could be constructed to have magnification characteristics through the use, in a different embodiment, of multiple lens layers 53, 54, as illustrated in FIG. 3. The multiple lens layers may be formed from clear or transparent polyvinyl chloride (PVC) material.

The magnification capability of the upper section 51 is not intended to be very high power levels, but to still provide an enhanced or magnified viewing capability for the user. By way of example, the magnification capability of the upper section 51 could be within the approximate range of three to five times magnification. In other embodiments, higher levels of magnification could be achieved using different lens capabilities incorporated into the upper section 51, or by using additional lens layers for the upper section 51.

The window 70 and door 60 sections may be incorporated into the cover 30 in a variety of configurations. For example, FIG. 1 shows one embodiment of the inclusion of a single door section 60 and a single window section 70. Alternatively, the window section 70 could be included within the door section 60, and the tent structure 10 could be manufactured with two door sections 60 such that both sides of the tent structure 10 has a door section and/or a window section 60.

As shown, the door section 60, once unzipped, or unfastened, may be readily rolled up towards the top of the tent structure, and secured in the rolled up configuration, to allow open access into the tent structure 10. Similarly, the window section 70, once unzipped, or unfastened, may be readily rolled up or down, depending upon the window orientation, to allow air into or out of the tent structure 10. In the embodiment shown, with the window section 70 open, wind and air flow are allowed pass into the tent structure 10, but still provide a high level of protection from sand or other wind-blown objects. Such window sections 70 also allow users to see out of the tent structure 10.

In a similar fashion, one or more cutouts, similar to the telescope cutouts 40a, 40b, may be incorporated into the cover 30, to allow for release of air pressure when wind blows into the tent structure 10. Such cutouts help to maintain the tent structure from inadvertently ballooning like a parachute, and moving when the wind blows and catches within the tent structure 10.

While shown in a particular “saddle shape” configuration in FIGS. 1 through 8, the night viewing tent structure 10 may be designed and configured into most any shape or size, including by way of example, and not by way of limitation, as a cube, cylinder, or a cone or teepee. Similarly the tent structure may be manufactured in different sizes, including variations in height, length or width.

A further embodiment of the night viewing tent structure 10 may include a floor section 50, shown in FIG. 3, that would be attached to the support rib 20a, and provide the user with some protection and separation from the ground or soil on which the tent structure 10 is deployed. More particularly, the floor may be attached to the support rib 20a using one or more fasteners 24, which could include, by way of example, hook and loop textiles, buckles, snaps, tie strings, buttons and button holes, or any other similar type of fastening mechanism.

As shown and described, the cover 30 may be flexible to allow for ready assembly, disassembly, and storage. The cover 30 may be manufactured from most any type of lightweight, flexible textile, such as nylon ripstop or similar types of polyester fabrics. Alternative and additional materials that may be used to manufacture the cover 30 include polyester, canvas, polyethylene, flexible polyvinyl chloride (PVC), as well as other flexible textiles, synthetic plastic polymers, and poly-type materials.

A further embodiment of the tent structure 10 may be an improved cover 30 that is manufactured with one or more coatings on the cover 30 where the coatings absorb ultraviolet radiation (UV). The ability to absorb UV rays provides a further level of protection for users of the tent structure 10. Because UV rays have a wavelength below approximately 400 nanometers (nm), the one or more coatings on the cover 30 should have properties of absorbing light rays having wavelengths of approximately 400 nm or less. An additional coating or coatings could be incorporated into or applied to the cover 30 to absorb other potentially harmful light waves. By way of example, further coatings could be applied to the cover 30 having properties to absorb light rays having wavelengths approximately less than 500 nm. Such coatings would protect users of the tent structure 10 from UV light as well as light rays above the UV spectrum.

As an additional feature of another embodiment of the night viewing tent structure 10, the flexible cover 30 could be manufactured to include photochromic features. Such photochromic properties would allow the cover 30 to be clear in low light or night conditions, and to be substantially tinted in full light or daylight conditions. The tinting of the cover 30 in full light or daylight provides users with further protection from potentially harmful UV sunlight.

In order to balance strength, durability, and weight, the ribs 20 may be manufactured from any type of resilient thermoplastic or composite material. With the ribs 20 being manufactured from a resilient thermoplastic, the ribs 20 may be readily formed into a figure-8 shape and folded into a compact size for transport and storage. When fully collapsed, the night viewing tent structure 10 is designed to be fairly compact, and storable a storage bag or sack (not shown).

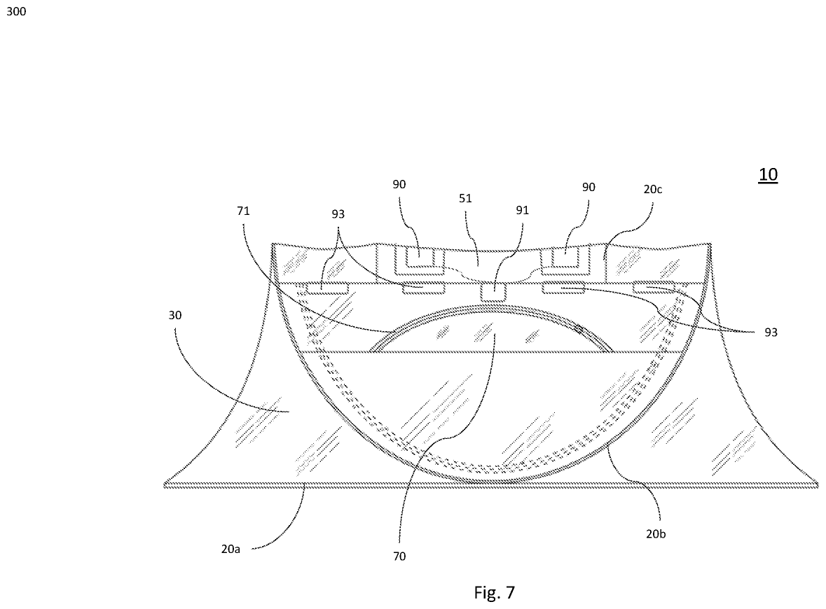

In a further embodiment, having a further enhanced feature, the night viewing tent structure may incorporate, as shown in FIG. 7, solar panels or photovoltaic panels 90 on the cover top sections, or embedded within the cover 30. Such photovoltaic panels 90 may be used to generate electrical power during the day when sunlight hits the panels. The photovoltaic panel 90 electrical power can be used to operate lights 93 or for recharging any type of rechargeable electrical devices. For improved useability, the tent structure 10 could further include electrical power storage units, such as batteries 91, such that the electrical power generated by the photovoltaic panels 90 during the daylight would be stored in the batteries 91, and then able to be used to power lights 93 during the evening and night hours. The use of light emitting diodes (LEDs) would provide the most efficient use of electrical power generated by the photovoltaic panels, and would provide additional safety over incandescent bulbs, which tend to generate excess heat.

The night viewing tent structure 10 may also include pockets or bags (not shown) for use to weigh down or provide ballast to the modules. For example, at the beach, sand can be easily placed in the bag sections, whereas for use with camping or non-beach activities, stones or a plurality of smaller rocks can be placed in the bag sections or pockets to provide additional weight or ballast. When it is time to collapse and transport the night viewing tent structure 10, the sand, stones, or small rocks may be readily removed from the bag sections, and disassembly or folding is easily achieved. For additional positional support and stability, the footprint or bottom rib 20a of the tent structure 10 can be anchored to the ground with removable stakes (not shown).

The drawings and disclosed embodiments are but a limited set of examples of how the inventive night viewing tent structure 10 may be used. For example, while the tent structure 10 is described as useful for night viewing or star gazing, other uses may be equally beneficial or relevant to users. Uses may include, without limitation, beach, camping, and other outdoor activities, such as use within a garden, at sporting events, a party shelter, a reading spot, a safe enclosure for pets, a leisure/quiet place, and/or set up and used by various commercial entities such as temporary covered spots by restaurants, spas, or resorts.

While preferred embodiments of the inventive night viewing tent structure and system 10 have been described and disclosed, in particular by reference to certain figures and exemplary embodiments relating to particular shapes, and configurations for the tent structure 10, such embodiments for the tent structure 10, are not to be construed as limiting the scope of application of the inventive devices or systems. For example, as described and claimed, the night viewing tent structure 10 may be configured having different sizes and shapes for the footprint, side sections, and top sections of the tent structure 10. Such variations to the tent structure side and top sections may include different dimensions, different shapes, and/or with the tent structure having multiple doors or windows incorporated into the cover 30. All such alternate embodiments are deemed to be within the scope of the inventive design and below claims.

It will be recognized by those skilled in the art that other modifications, substitutions, and/or other applications are possible, and all such modifications, substitutions and applications are within the true scope and spirit of the present invention. It is likewise understood that the above disclosure and attached claims are intended to cover all such modifications, substitutions, and/or applications.

What is claimed is:

1. An outdoor tent for night sky viewing, comprising:
A plurality of flexible ribs;
A flexible cover attachable to said plurality of flexible ribs to form a tent structure, wherein said flexible cover
is substantially transparent for at least approximately 33% of the top of said tent structure;
has at least one openable side door panel;
has at least one opening in the top of said tent structure for a telescope lens to extend through.

2. The outdoor tent, as described in claim 1, wherein said tent structure further comprises at least one openable side window.

3. The outdoor tent, as described in claim 1, wherein said tent structure transparent top section has at least one magnifying portion, with a magnification of approximately greater than three times.

4. The outdoor tent, as described in claim 1, wherein said tent structure transparent top section at least one magnifying portion has a magnification of approximately greater than five times.

5. The outdoor tent, as described in claim 1, wherein said flexible cover is manufactured with at least one coating that absorbs ultraviolet radiation below approximately 400 nm.

6. The outdoor tent, as described in claim 1, wherein said flexible cover is manufactured with at least one coating that absorbs light radiation below approximately 500 nm.

7. The outdoor tent, as described in claim 1, wherein said flexible cover has photochromic features to be clear in low light or night conditions, and to be substantially tinted in full light or daylight conditions.

8. The outdoor tent, as described in claim 1, wherein said flexible cover is at least partially manufactured from a synthetic plastic polymer including at least one of a polyethylene material and a polyvinyl chloride material.

9. The outdoor tent, as described in claim 1, further comprising at least one photovoltaic panel attachable to at least a portion of said tent structure top section.

10. The outdoor tent, as described in claim 9, further comprising at least one light emitting diode electrically connected to said at least one photovoltaic panel.

11. The outdoor tent, as described in claim 9, further comprising at least one energy storage device to store electrical power generated by said at least one photovoltaic panel.

12. The outdoor tent, as described in claim 1, wherein said at least one photovoltaic panel is incorporated into said tent structure transparent top section and is flexible.

13. The outdoor tent, as described in claim 1, wherein said flexible cover further comprises a plurality of stakes to anchor said outdoor tent to the ground.

14. The outdoor tent, as described in claim 1, wherein said plurality of flexible ribs are manufactured from at least one of thermoplastic material, aluminum, steel, and fiberglass.

15. An outdoor tent for night sky viewing, comprising:
A single flexible rib in an approximate oval shape;
A flexible cover attachable to said single flexible rib to form a tent structure when opposite sides of said single flexible rib are folded towards each other, and wherein said flexible cover
is substantially transparent for at least approximately 50% of the top of said tent structure;
has at least one openable side door panel;
has at least one opening in the top of said tent structure for a telescope lens to extend through.

16. The outdoor tent, as described in claim 15, wherein said single flexible rib sides folded towards each other are anchored to the ground with a plurality of stakes.

17. The outdoor tent, as described in claim 15, wherein said tent structure further comprises at least one openable side window.

18. The outdoor tent, as described in claim 15, wherein said tent structure transparent top section has at least one magnifying section, with a magnification of approximately greater than three times.

19. The outdoor tent, as described in claim 15, wherein said tent structure transparent top section at least one magnifying section has a magnification of approximately greater than five times.

20. The outdoor tent, as described in claim 15, wherein said flexible cover is manufactured with at least one coating that absorbs ultraviolet radiation below approximately 400 nm.

21. The outdoor tent, as described in claim 15, wherein said flexible cover is manufactured with at least one coating that absorbs light radiation below approximately 500 nm.

22. The outdoor tent, as described in claim 15, wherein said flexible cover has photochromic features to be clear in low light or night conditions, and to be substantially tinted in full light or daylight conditions.

23. The outdoor tent, as described in claim 15, wherein said flexible cover is at least partially manufactured from a synthetic plastic polymer including at least one of a polyethylene material and a polyvinyl chloride material.

24. The outdoor tent, as described in claim 15, wherein said single flexible rib is manufactured from at least one of thermoplastic material, aluminum, steel, and fiberglass.
